(19) United States
(12) Patent Application Publication
(10) Pub. No.: US 2016/0332123 A1
(43) Pub. Date: Nov. 17, 2016

(54) ENHANCED NUCLEATING BEVERAGE CONTAINER, SYSTEM AND METHOD

(71) Applicants: James A. Trulaske, St. Louis, MO (US); Stephen M. Schmitt, (US)

(72) Inventors: James A. Trulaske, St. Louis, MO (US); Stephen M. Schmitt, (US)

(21) Appl. No.: 15/105,496

(22) PCT Filed: Apr. 20, 2015
(86) PCT No.: PCT/US15/26727

§ 371 Date: Jun. 16, 2016

Related U.S. Application Data
(60) Provisional application No. 61/981,320, filed on Apr. 18, 2014.

(51) Int. Cl. B01F 3/04; A47G 19/22; B65D 85/73; A23L 2/54

(52) U.S. Cl. CPC B01F 3/04794; B01F 3/04439; A23L 2/54; A47G 19/2233; B65D 85/73; B01F 2003/049; A23V 2002/00

(57) ABSTRACT

A nucleating beverage container, system, and method, for effervescent beverages, incorporating nucleating features or sites at different elevations about a cavity of the container, configured to cooperate to generate an enhanced amount of smaller bubbles that will rise within and accumulate on the surface of the beverage as a collar or head, designable to do so without reducing the carbonation of the beverage so as to degrade taste or go flat within a prescribed time, and which can limit thermal convection of the beverage within a lower region of the container, to reduce warming and degradation of quality of the last to be consumed portion of the beverage.

This application is submitted under 35 U.S.C. 371 claiming priority to PCT patent application Serial No. PCT/US2015/26727, filed Apr. 20, 2015, which application claims the benefit of U.S. Provisional Application No. 61/981,320, filed Apr. 18, 2014.

### TECHNICAL FIELD

This invention relates generally to a nucleating beverage container, system, and method, particularly for carbonated and other effervescent beverages, incorporating nucleating features or sites at different elevations about a cavity of the container, configured to cooperate to generate an enhanced amount of smaller bubbles rising within and accumulating on the surface of the beverage, and which can be designed so as to do so without reducing the carbonation or other dissolved gas or gases of the beverage so as to degrade taste or go flat within a certain time, and which can limit thermal convection of the beverage within a lower region of the container, to reduce warming and degradation of quality of the last to be consumed portion of the beverage.

### BACKGROUND ART

The disclosure of U.S. Provisional Application No. 61/981,320, filed Apr. 18, 2014, is hereby incorporated herein in its entirety by reference.

Liquid beverages containing dissolved or absorbed gas or gases in solution, are well known. Particularly well known among those beverages are beers, ales, stouts, and other fermented products, and soft drinks, which are carbonated, that is, they contain carbonaceous gas, principally carbon dioxide. Some beers, particularly, stouts and ales will additionally be nitrogen gas in some amount.

The amount of equivalent gas contained in the beverage, for instance, beer or ale, will typically range from between about 1 to about 4 volumes. For example, for 1 liter of beer carbonated to 2.7 volumes, that beer will contain about 2.7 liters of carbon dioxide gas at a designated standard temperature and pressure, dissolved in the beer. If the carbonation for a particular beer falls below its designated volume, it will typically be considered no longer fresh or even flat, and is undesired from both the consumer and vendor perspective. Some hold the opinion that even a small deviation in the carbonation volume can be considered detrimental, as it will result in noticeably different taste and/or loss of freshness. On the other hand, if the carbonation exceeds the designated volume, the beer may not dispense or pour as desired for that product, e.g., may be foamier with too large of a head, and may even be impossible to satisfactorily dispense in a liquid state. As a result, volume content of carbonation is a closely monitored quality characteristic by many brewers, particularly for beers and ales.

To maintain carbonation, consistency, and other properties, carbonated beverages are typically stored under pressure, until dispensed for consumption, e.g., poured into a glass or cup for drinking, or into a pitcher for pouring into glasses or cups for drinking. Using beer as an example beverage, when dispensed, e.g., poured, from its pressurized container, e.g., keg, barrel, bottle, can, etc., into another container for consumption, e.g., the beer will begin to lose some of the absorbed gas to atmosphere. If consumed too slowly, the remaining beer can lose sufficient carbonation so as to be considered flat or not fresh. Some beers will lose carbonation faster, or otherwise become flatter or lose freshness sooner than others. This is also an important characteristic of beers that is monitored by brewers for quality control purposes.

When dispensed for individual consumption, it is often desired to have a certain level or height of foam on the upper surface of the beverage, particularly, on beers and ales, referred to as a head or collar. This is referred to commonly as the presentation. A typical desired head or collar will have a height of from a significant fraction of an inch to an inch or so, e.g., ½ inch or so, and will appear creamy with small foamed bubbles. The head can be created during the initial dispensing or pouring of the beer, but if too short or thin, may diminish unacceptably within less than 2 minutes or so, which lessens the presentation effect and appeal of the beer amongst many consumers. Examples of typical unacceptable degradation of the head include substantial lack or disappearance of the foam, and breaking up of the foam, such that the upper surface of the beer is largely visible, so as to suggest lack of freshness or flatness, that is, loss of carbonation. As a practical example, if a beer is drawn at a bar by a bartender, then picked up by a server and served to a consumer at a table several minutes later, it may have lost substantial collar or head by the time it reaches the consumer, so that, based on appearance only, it may be considered less fresh, even if the flavor is not noticeably degraded. This is particularly undesirable when a mass market beer or ale is served beside a craft beer having a creamier head, as it makes the mass market beer appear less desirable.

As another concern in this regard, the carbon dioxide of the head or collar will continually release aroma, which is desired by some drinkers. Because the carbon dioxide is heavier than the components of air, it will tend to accumulate more in the upper portion of a container while head or collar is present compared to when not present, so as to further enhance the drinking experience.

To counter the natural loss of head or collar, and to build the collar in a dispensed carbonated or other effervescent beverage, for improving presentation and maintaining freshness and aroma, it is well known to provide nucleation sites within the open beverage container, including glasses, mugs, steins, and the like, of various shapes. Such nucleation sites typically comprise an imperfection, flaw, particle or feature such as an etched, scratched, sandblasted, printed or embossed area or feature, on which the carbonaceous gas, typically carbon dioxide, will nucleate or transition from dissolved within the liquid beverage to the gaseous state, thereby forming bubbles of gas within the liquid beverage attached to the nucleation site. Typically, when the bubbles reach sufficient buoyancy, the upward buoyancy forces will overcome surface tension forces holding the bubbles to the surface, and the bubbles will detach from the nucleation sites and rise within the beverage to its upper surface.

One observed problem is that the bubbles can burst immediately upon reaching the surface, or reside for some time there and eventually burst, if the beverage is not consumed before that time. Another observed problem is that rising bubbles can collide and coalesce into larger bubbles, which are less aesthetically desirable in the opinion of many. For best appearance in the opinion of many, the bubbles will collect so as to substantially completely cover the upper surface of the beverage, and be individually small so as to impart a creamy appearance to the head. As the best drinking experience, many want to drink the liquid beer through a finely bubbled or foamed collar, or drink some of the foam with the liquid, due to its creamy texture. Smaller bubbles are advantageous from a longevity standpoint as they have a lower surface tension. Often an upper fraction of the height of a beverage container such as a beer glass, mug, or stein, will be denoted as a collar zone or region, as a non-limiting example, form a fraction of an inch, to 1-2 inches or so from the top, and may have a visible collar or pour line delineating the collar zone from the lower region intended to hold the liquid beverage.

Reference European Patent Application Publication EP0598766 A1, published Jun. 1, 1994, which discloses a glass and method of inducing the evolution of bubbles in a carbonated beverage, which recites that the interior of the glass is treated to provide nucleation sites on the surface of the glass whereby, in use, to stimulate evolution of bubbles in a carbonated beverage in the glass in a controlled manner. It is further recited that the nucleation sites are suitably in a minor part of the area of the interior, preferably at a lower part of the glass, more preferably on a base portion of the glass.

EP0598766 A1 further explains that although it would be possible to appropriately treat the whole area of the base portion (even the whole glass) to produce bubbles, in a typical glass, it has been found with some treatments that not only does this tend to cause the base portion of the glass to look opaque and aesthetically unattractive but also excessive bubble formation can tend to arise. Thus, preferably the treated area is a minor part of the base portion which occupies less than 10% of the area of the base portion, for example about 5% of the area, or even less when using some etching techniques. In a preferred glass in accordance with the invention of EP0598766 A1, the base portion consists of a base which is circular in plan and the minor part of the base is an annular region of the base adjacent the junction of the side wall with the base of the glass, and preferably as close as possible to the side wall. It is further explained that a narrow ring around the base of the glass is not only difficult to see but tends to promote nucleation in such a way as to provide a very desirable appearance for bubble generation in beer. The minor part may consist, alternatively, or in addition to an annular ring, of a treated region in a central portion of the base portion of the glass, suitably in the form of a logo. This provides a stream of bubbles of unusual appearance which may provide an attractive feature in some circumstances. As further alternatives, EP0598766 A1 explains that the minor part may comprise a complex pattern of lines, a diffuse pattern of dots, pictures, alphabet characters, numbers, writing or combinations of these, or other configurations.

EP0598766 A1 explains that the treated part may be produced by any suitable method. However, it is pointed out that certain techniques which involve scratching of the treated region, e.g. the base portion, for example with a diamond glass cutter, while providing some effect, are not acceptable on a commercial scale for a number of reasons, for example, scratches tend to grow and weaken the glass so that it is more prone to breakage and also may harbour microorganisms adversely affecting hygiene, as well as being unsightly. Preferred treatments according to that patent application include sand blasting or acid etching of the region to be treated which does not significantly weaken the glass and permits washing procedures which can effectively remove contaminants from the treated region. The treatment is effected to provide the degree of roughness necessary to provide a desired amount of nucleation in the beverage intended to be supplied in the treated glass.

Other representative patent documents that disclose nucleation sites within drinking glasses or vessels include WO9500057A1 published Jan. 5, 1995, which discloses use of annular rings imparted on the bottom region of a glass, including on bottom of a side wall of the glass; DE3230578A1 published Feb. 23, 1984, which discloses release points in the side of a glass; and U.S. Pat. No. 4,322,008 issued Mar. 30, 1982, which incorporates a design into the bottom of a glass. Each of the above patent documents, uses as the illustrated embodiments of the respective invention, the nucleation sites in or on the bottom of the glass, or on the side very close to the bottom, or just a series of individual vertically spaced nucleation points extending upwardly on the side of the glass.

A disadvantage observed when using nucleating from the lower locations within a glass is that they will generate bubbles in the region of the beverage to be consumed last, that is, in the lowest region of the glass, which has been found to result in undesirable loss of carbonation and freshness, and even flatness of the beverage, before the portion in the lower region of the container is consumed. As another discovered disadvantage, the volume of bubbles generated by nucleating from the bottom or lower region of the glass or other container to any significant extent has also been found to result in accelerated warming of the lower or last to be consumed portion of the beverage. It has additionally been found that these disadvantages are exacerbated when the consumption of the beverage is delayed or prolonged, such as, if the beverage is being consumed with dinner or during extended conversation. As a result, any advantage achieved by improved presentation and head, is offset by degradation in freshness and quality at or near the end of the drinking experience.

Addressing use of vertically spaced apart very small individual nucleation points as illustrated in DE3230578A1, while this may be adequate for generating interest in wines, it has been found to be insufficient for building or significantly enhancing head or collar on beer. This small number of nucleation sites also lacks usefulness if it is desired for them to form an aesthetically attractive design, logo, or trademark.

U.S. Published Patent Application 2010/0104697 A1 published Apr. 29, 2010, discloses a bottle or other container for a carbonated beverage that provides controlled bubble release utilizing a pattern of applied nucleation sites, including lines of nucleation sites. A variety of designs comprising patterns of nucleation sites on a container base are illustrated in the publication, including several famous trademarks. What is not disclosed in the publication is whether the generated bubbles would be adequate for generating a sustained covering head or collar on a liquid beverage, particularly a beer or ale, however, the present inventors have observed the bubble generation performance of several glasses having nucleation zones comprising similar logos and writings and filled with beer which were inadequate to provide a totally covering head or collar. As another observation, designs, logos and trademarks located on the bottom of glasses containing beer or other colored beverages, have generally only been readable when the glass is close to empty or is tipped to expose the bottom.

As a note in regard to use of nucleation sites to produce a design, logo or trademark of a desired size or visibility in contrast to the beverage, through experimentation the present applicants have found that a larger than desirable number of the sites may be required and can thus result in premature de-carbonation and degradation of taste, and thus this can be a limiting factor on design choices.

Thus, what is sought is a manner of improving presentation of carbonated and other effervescent beverages, principally beers, ales, and the like, by enhancing, maintaining, or building a head or collar by nucleation, and which can be embodied if and as desired in an aesthetically pleasing design, logo, and/or trademark of a desired size, which reduces or eliminates one or more of the disadvantages and limitations of presently known nucleation apparatus and methods referred to above.

### SUMMARY OF THE INVENTION

What is disclosed is an apparatus, system, and method of improving presentation of carbonated and other effervescent beverages, principally beer, by enhancing, maintaining or building a head or collar by nucleation, but which reduces or eliminates one or more of the disadvantages and limitations of presently known nucleation apparatus and methods referred to above.

According to a preferred aspect of the invention, multiple nucleation sites are arranged in at least one pattern or zone, configured to achieve a multiplying effect of bubble nucleation and detachment, to generate an enhanced number of desirably small bubbles to create, build and/or maintain the collar. To reduce de-carbonation and warming of the last to be consumed portion of the beverage, the lowermost of the nucleation sites are located and arranged to form an upward bubble flow or convection cell that acts as a barrier or block to upward convection flow of the beverage from regions of the container below the lowermost sites. As a non-limiting example, the nucleation sites are preferably located within a range encompassing about the upper ¾ or so of the overall height of the interior of the glass or container, and more preferably the upper ⅔ of the height of the container or so. Thus, as an advantage, the beverage in the lower about ¼ or ⅓ of the container will produce only minimal bubbles, to preserve carbonation and coolness of that portion of the beverage which is the last to be consumed portion of the beverage.

As an advantage of the invention, smaller, more numerous bubbles are generated, particularly at the upper nucleation sites, to provide the collar or head with a creamier foamed appearance. The smaller bubbles also have lower surface tension so they have been found to last longer than larger bubbles. This has been found to be advantageous for increasing both aesthetic appeal and aroma. One preferred manner of creating smaller, more numerous bubbles and the resulting finer foamed appearance according to the invention, is to locate multiple nucleation sites in zones at generally vertically aligned lower and higher elevations on the interior surface of the sidewall of the glass or container, in a manner and relationship such that bubbles that detach from the nucleation sites of the lower zone or zones enhance nucleation at higher sites, in particular, to create smaller and more numerous bubbles at those sites than would be generated with just multiple nucleation lines or sites acting independently. For applications wherein the sidewall of the container is tilted relative to vertical, such as a standard pint glass wherein the sidewall is at between about a 3 degree and a 15 degree angle to vertical, wherein the bubbles would ordinarily just rise generally vertically from the individual nucleation sites, the present invention configures the upper and lower sites in a cooperative manner so that the upper sites produce a greater number of smaller or finer bubbles.

One representative manner of enhancement according to the invention involves positioning the lower nucleation sites or zones in relation to upper sites, so that bubbles that detach from the lower sites or zones will pass closely by the upper sites or zone and cause or facilitate premature detachment of the bubbles attached at the upper sites, but without significant physical contact between the bubbles from the lower sites and those of the upper sites, so that increased bubble creation is achieved at the upper sites, but the bubbles don't coalesce into large bubbles to a significant extent.

According to a non-limiting preferred aspect of the invention for incorporating the invention into a common container, e.g., having sloped sidewalls, such as, but not limited to, various commercially available pint beer and ale glasses and the like, e.g., having a sidewall slope of between about 3-15 degrees from vertical (inclined to extending radially outwardly from the center of the cavity and upwardly) it is desired to cause the bubbles that detach from the lower nucleation sites or zones, to rise in a manner so as to stay close to the sidewall, and not just rise vertically as with known nucleation arrangements. To achieve this effect, it has been found that by providing the lower nucleation sites in a sufficient density such that the bubbles that detach and rise from a limited area in essentially a continuous flow or stream, a boundary layer flow can be developed, which will attach to the sidewall for a useful portion of the height of travel of the bubbles. Additionally, the lower nucleation sites can be spaced below the upper nucleation sites by an advantageous distance, so that the bubbles that rise from the lower sites will accelerate as they rise to achieve a velocity for better effecting premature detachment of the bubbles attached at the upper sites.

One preferred manner of creating the nucleation sites in a suitable configuration, e.g., size, density, durability, uses a laser to etch a two dimensional pattern of the nucleation sites at a high dpi (dots per inch) pulsating setting, such as but not limited to, between about 300 dpi and maximum dpi setting for the laser.

According to another preferred aspect of the invention, when the nucleation sites are provided in suitable density to form the desired boundary layer flow, and the lower nucleation zone or zones is/are positioned a suitable distance below the upper nucleation zone or zones, the concentrated rising bubble flow from the lower zone will flow closely past, but not significantly contact, the still attached bubbles at the higher nucleation sites, and cause a significant number of them to prematurely detach and rise also. Here, it should be noted that this spacial relationship between the lower and upper nucleation zones is desirably selected so as to avoid substantial collisions between and resultant coalescence of the respective bubbles into larger bubbles, which has been found to be possible as a result of characteristics of the boundary layer flow.

As a theory to explain the premature detachment of the bubbles within the upper zone, it is believed that the passing bubbles have an associated pressure wave, analogous to the bow wave created by movement of a boat through water, that is sufficient at the upward velocities achieved by the spacing of the lower zone from the upper zone, to exert forces against the attached bubbles, that in combination with buoyancy forces acting upwardly against the attached bubbles resulting from the gas contained therein, will be sufficient to cause the attached bubbles to detach, by overcoming the surface tension holding the bubbles to the surface of the sidewall. It is also believed that low pressure trailing regions following the rising bubbles, and/or the succession of multiple pressure waves, exert lateral forces against the attached bubbles, and may be a factor in the bubble creation and detachment, by drawing the existing attached bubbles toward the upward flow stream after passage of the rising bubbles and associated pressure waves, so that an oscillating pulsing action is exerted against the attached bubbles to facilitate detachment. The trailing lower pressure region when passing the nucleation sites and related trailing eddy currents are also believed to act as a catalyst to the nucleation, mainly to accelerate formation and growth of the attached bubbles prior to the premature detachment. As a result, it is observed that the bubbles detach prematurely and more frequently compared to when acted upon by buoyancy only in the absence of the flow of bubbles from below, so that the bubbles are generally smaller, which creates the creamier foamed head and its benefits.

According to another preferred aspect of the invention, to further enhance generation of smaller, more numerous bubbles in a controllable manner, the upper and lower nucleation sites or zones are spaced optimally to maximize the effect of the passing flow of bubbles. In this regard, it is observed that the bubbles will accelerate as they rise, and thus the lower nucleation sites can be positioned a spaced distance below the upper sites so that the bubbles from the lower sites rise past those sites within a velocity range found beneficial for causing detachment of the bubbles at the upper sites. This distance will likely be a function of several factors, including density, viscosity, and temperature of the beverage, angle of incline of the sidewall, and bubble generation characteristics at the respective upper and lower sites or zones, and so may be different for different applications. It is thus contemplated that the configuration and location of the nucleation zone or zones for a particular container, can be selected as a function of the beverage to be served and the desired head or collar characteristics to be achieved.

The nucleation sites at upper and lower elevations are preferably arranged in dense zones or patterns having a vertical extent comprising multiple close together or abutting nucleation sites sufficient to produce a desired number and density of bubbles. As a non-limiting example, a suitable number and density of nucleation sites has been found to be created using a laser in a pulsing mode, such as, but not limited to, a 20 to 50 watt carbon dioxide laser operating at between about 300 and a maximum dpi (dots per inch pulsing) value for the laser used. Operating at between about 600 and 1200 dpi at from about ½ to full power, the laser has been found to spall glass to a much larger lateral extent than suggested by the dpi rate used. What has resulted is shallow crater-like depressions, the craters overlapping creating angularly related ridges therebetween in a lattice like effect, and in sufficient quantity to provide ideal and robust nucleation sites. With this high density application of laser etching, even what visually appear to be thin nucleation zones or lines, can actually contain a large sectional extent of the craters, ridges and nucleation sites, to provide robust bubble generation.

As another observed advantage of the invention, as the velocity of the rising bubbles increases, they appear to repel each other, which spreads the flow, so that it appears to break away from the boundary layer and become more free flowing. This is attributed to increase in the force and velocity of the associated pressure waves, and appears to reduce collisions between the bubbles and coalescence into larger bubbles.

As a result of the above explained configurations of nucleation sites according to the invention, it has been found that the rate of generated bubbles can are sufficient for enhancing collar or head on a beer, both by building or adding to the collar, and for maintaining existing collar, in a manner to provide desired presentation.

As still another preferred aspect of the invention, an upper arrangement of nucleation sites can be located close to or coexistent with the lower region of the collar region of the container, that is, close to or about the pour line if present. This is especially advantageous when the beverage has been dispensed with no or only a small collar, or the beverage has been dispensed into the container with adequate collar, but service to the consumer is delayed so that if a prior art container were used, the collar would be undesirably non-existent, small, or reduced when the beer is served. In this situation, with the invention, when the container is filled sufficiently to immerse the upper nucleation sites, they will operate to nucleate sufficiently to generate the desired collar, then, as the collar reaches and encompasses the nucleation sites, that is, it expands downwardly, the bubble generation will be reduced so as generate only sufficient bubbles to maintain the collar, or cease if the zone is completely ensconced in bubbles. Then, if the collar liquefies to such an extent that the sites are again immersed in liquid, nucleation will resume. Thereafter, as the beverage is consumed the upper nucleation sites will not be immersed, and thus will no longer be a nucleating factor.

As a related benefit, if when the beverage is poured into the container the head or collar is too large so as to downwardly into an upper extent of the uppermost nucleation zone or line, bubble generation in the region containing the foam will be absent, but will initiate if that portion of the collar liquefies in that region.

As another preferred aspect of the invention, the nucleation sites configured to operate in the above described manner can extend uninterruptedly about all or a substantial portion of the inner surface of the container, or be located at intervals thereabout. They can also be optionally comprise designs or words, logos, trademarks, and the like, such as, but not limited to, representative of the beverage and/or beverage maker, so as to provide an advertising opportunity, with the physical effect of substantially enhanced bubble generation. As noted above in this regard, it has been observed in the prior art that too many nucleation sites within a container can result in unacceptable de-carbonation. This can have a limiting effect on the size of the designs, logos, etc. As another preferred aspect of the invention, non-nucleation sites can be mixed together with the nucleation sites, and have essentially the same appearance, to eliminate need to reduce the number of actual nucleation sites. It has been found in this regard that the nucleation sites and non-nucleation sites can be produced in the same manner, e.g., by a pulsating laser, using power levels that spall the surface of a container in a manner that only some of the sites nucleate bubbles. As a related advantage, the spalling in this manner has been found to produce cleaner, crisper edges at interfaces with unspalled portions of the surface, and less occurrence of attached chips and crevasses of material of the container, e.g., glass, that can break off later or harbor contaminants.

As still another feature of the invention, it has been found that the lowermost nucleation zone of the invention can have a limiting or blocking effect on thermal convection in the region of the container therebelow, so that the last to be consumed portion of the beverage contained in that region is subjected to less warming and thus remains cooler. There is also no nucleation according to the invention in the lower region, so that less de-carbonation will occur there and the last to be consumed portion of the beverage will be fresher, if consumed within a reasonable time after serving of the beverage.

### BRIEF DESCRIPTION OF THE DRAWINGS

FIG. 1A is a sectional views of a representative beverage container with which the invention can be used;

FIG. 1B is a sectional views of another representative beverage container with which the invention can be used;

FIG. 1C is a sectional views of another representative beverage container with which the invention can be used;

FIG. 2 is a sectional view of the container of FIG. 1A, illustrating aspects of an embodiment of apparatus and a system for enhanced nucleation and collar creation according to the invention;

FIG. 3 is an enlarged fragmentary sectional view of the container of FIGS. 1A and 2, showing aspects of the nucleation by the apparatus and system of the invention;

FIG. 4 is another enlarged sectional view of the container, showing additional aspects of the nucleation by the apparatus and system of the invention;

FIG. 5 is another enlarged sectional view of the container, showing aspects of the nucleation by the apparatus and system of the invention;

FIG. 6 is a further enlarged sectional view of the container, showing additional aspects of the nucleation by the apparatus and system of the invention;

FIG. 7 is another sectional view of the container, showing elements of the apparatus and system of the invention for forming the nucleation sites or a mixture of nucleation and non-nucleation sites on an inner surface of a sidewall of the container;

FIG. 8 is an enlarged sectional view of the container, showing schematically elements of the apparatus and system of the invention forming an individual nucleation site (or non-nucleation site) on the inner surface;

FIG. 9 is an image showing a representative portion of a zone of nucleation sites and non-nucleation sites formed in a glass surface according to the invention;

FIG. 10 is an image showing a test specimen including nucleation sites formed according to the invention immersed at an incline in a beverage and generating a rising flow of bubbles closely along the surface of the specimen;

FIG. 11 is an image showing a foamed collar formed by the test specimen of FIG. 10 (observe absence of foam adjacent to the near surface of the specimen containing no nucleation sites of the invention);

FIG. 12 is an image of a test specimen, showing representative designs and writing comprising a mixture of nucleation sites and non-nucleation sites;

FIG. 13 is an image of another beverage container including lines of nucleation sites and non-nucleation sites about an inner surface thereof according to the invention;

FIG. 14 is a representative pattern of nucleation sites, or a mixture of nucleation sites and non-nucleation sites, comprising bands or lines of words, that can be formed on the inner surface of a container according to the invention;

FIG. 15 is an enlarged image of a beverage container including lines comprising a mixture of nucleation sites and non-nucleation sites in text form, showing bubbles forming and rising therefrom according to the invention;

FIG. 16 is a representative pattern of nucleation sites, or a mixture of nucleation sites and non-nucleation sites, comprising solid textured bands, that can be formed on the inner surface of a container according to the invention;

FIG. 17 is an enlarged image of another beverage container including bands comprising a mixture of nucleation sites and non-nucleation sites, showing bubbles forming and rising therefrom according to the invention, including larger bubbles forming and rising while accelerating from a lower band, and a larger number of smaller bubbles forming and rising from an upper band;

FIG. 18 is another enlargement of a portion of the container of FIG. 17, showing the larger bubbles forming and rising from the lower band, and the larger number of smaller bubbles forming and rising from the upper band; and

FIG. 19 is still another enlargement of the container of FIG. 17, showing the larger bubbles forming and rising from the lower band, and the larger number of smaller bubbles forming and rising from the upper band.

### DETAILED DESCRIPTION OF THE INVENTION

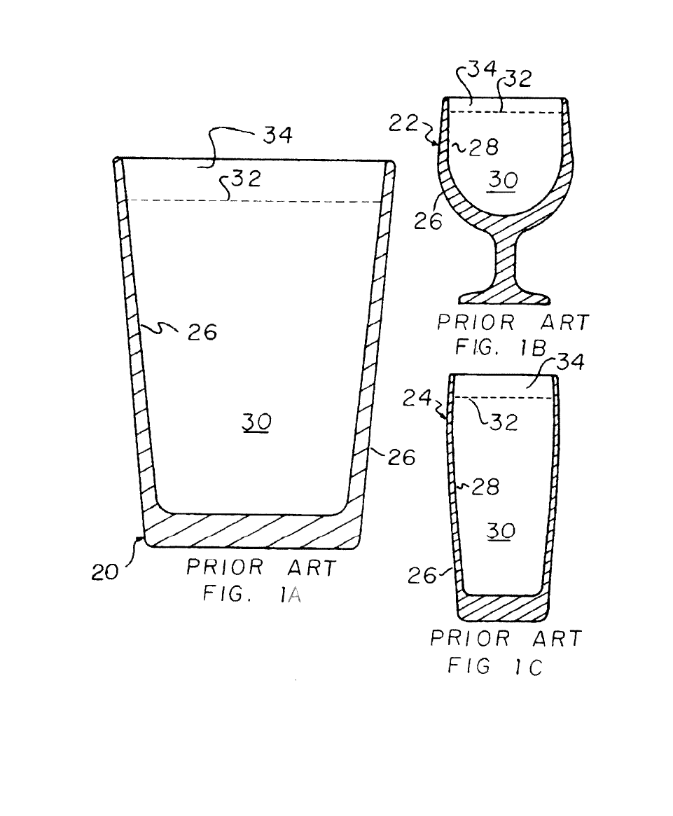

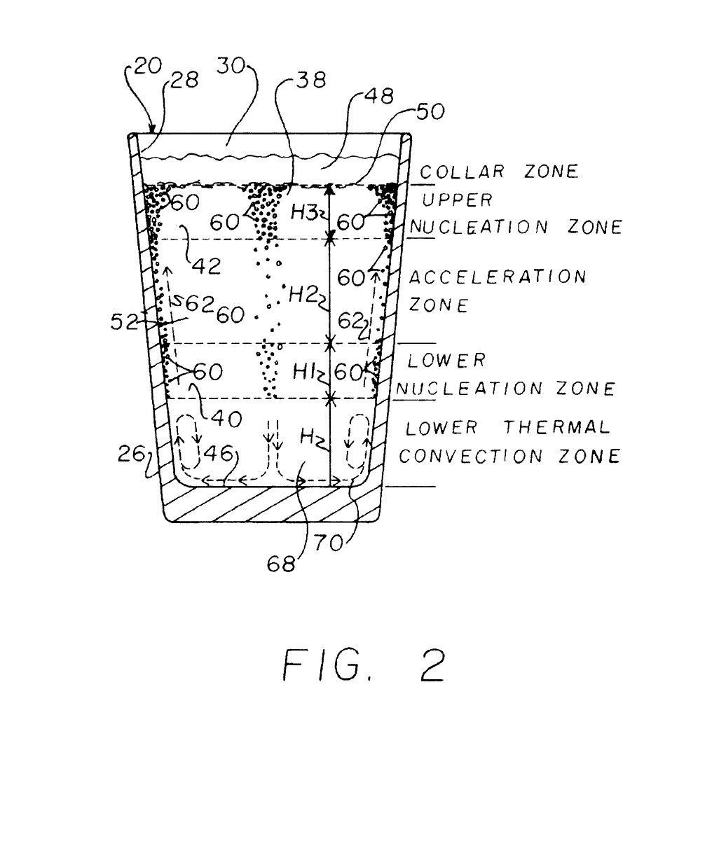

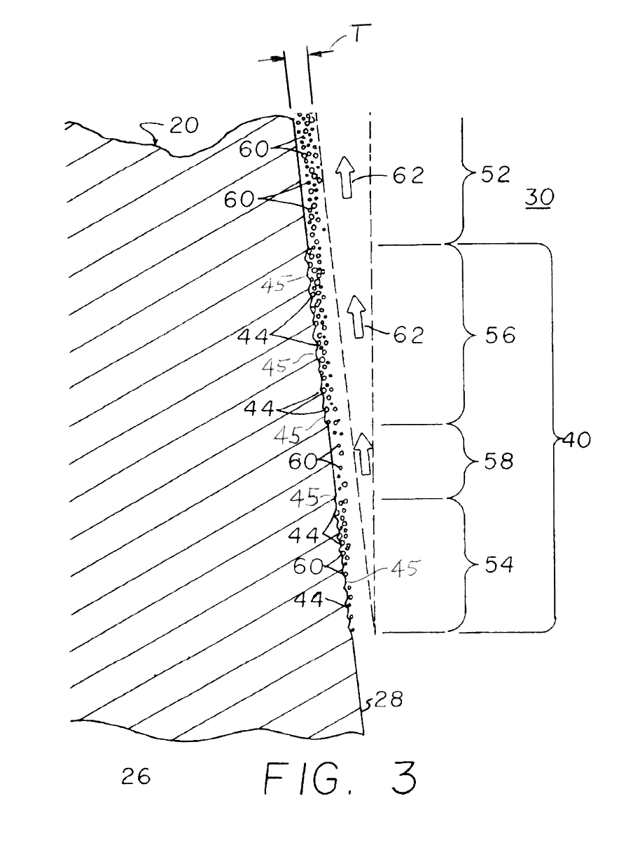

Referring now to the drawings, FIGS. 1A, 1B and 1C, show representative commercially available prior art beverage containers 20, 22, and 24, to illustrate just a few of the types of containers with which the present invention can be used. Container 20 is a conventional widely commercially available pint glass container, container 22 is a bowl style, and container 24 is a tulip style, each of which can be made of a suitable material, such as, but not limited to, glass or plastics, and each of which can be generally defined as including a sidewall 26 having a generally upstanding inner surface 28 bounding an upwardly open cavity 30 for receiving and holding a liquid beverage, which for purposes here will be a carbonated beverage, particularly a beer, ale, or stout. These and any of the other containers with which the invention is used can be round, oval other curved shape, or polygonal in sectional shape when viewed from above. Here, it should be understood that the present invention can be incorporated into a wide variety of beverage containers, including additionally, but not limited to, cups, mugs, goblets, tumblers, wine glasses, pitchers, and the like.

It can be observed that each of containers 20, 22, and 24 has a dotted line across inner surface 28, which denoted as a “pour line” 32, to which the liquid beverage will desirably be poured when the filling the container, the portion of cavity 30 above pour line 32 typically being denoted as a “collar zone” 34 and which will desirably contain the beverage in a foamed state to some extent when the container is considered filled with the beverage. As a non-limiting example, collar zone 34 will commonly have a vertical extent of about an inch or less, and a typical collar or “head” of foamed beverage will have a vertical extent of a fraction of the collar zone 34, for example, ⅛ to ½ inch. In this latter regard, as discussed above, it is typically desired for the foamed collar to have a rich, creamy consistency, preferably fully covering the liquid beverage below, for best presentation. Common concerns in regard to collar include poor initial quality, such as thinness and poor coverage which can be due to dissipation of the foamed collar to an extent that it includes voids and unattractive large bubbles resulting from coalescence of smaller bubbles into much larger bubbles than would be normally considered foam. Generally, the smaller the bubbles comprising the collar, and the more robust it is, up to the upper limit of the collar zone 34, the more satisfactory it will be considered to be, and the higher the quality of the beverage.

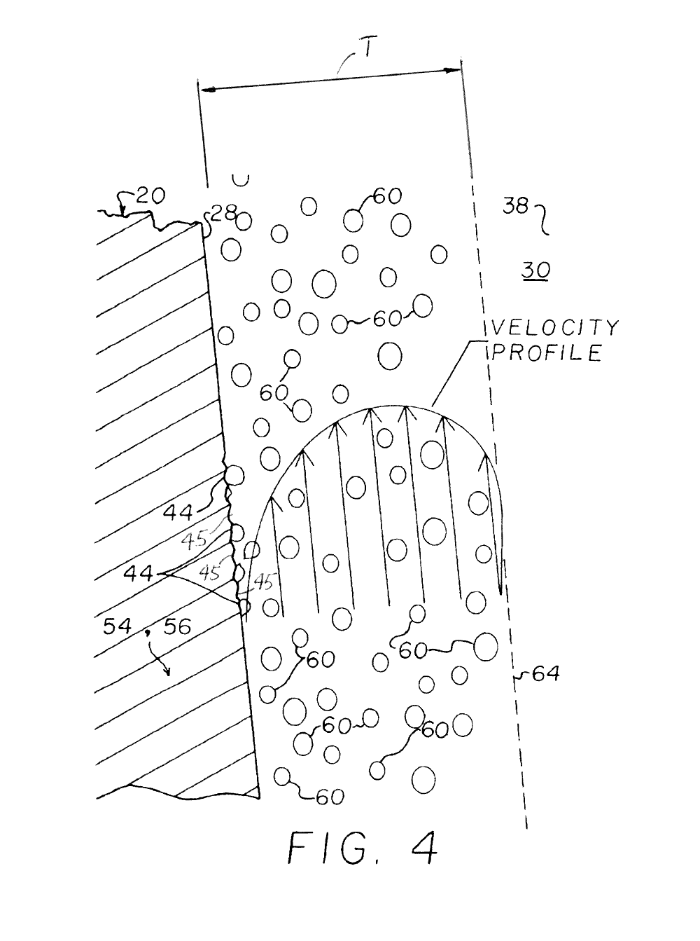

Referring also to FIGS. 2 through 6, container 20 is again illustrated in section, showing a segment of inner surface 28 of sidewall 26 about cavity 30, incorporating exemplary apparatus 36 of a system and method of the invention for enhancing nucleation within a liquid beverage 38 held in cavity 30, for achieving the desired collar or head characteristics for the beverage.

As best shown in FIG. 2, apparatus 36 here includes two nucleation zones, a lower nucleation zone 40, and an upper nucleation zone 42, although it should be understood that, depending on the results sought, the invention can be embodied using just one nucleation zone or line, or several. Each of zones 40 and 42 comprises a plurality of nucleation sites 44 and extends substantially completely peripherally about cavity 30, although, again, they can extend intermittently, or only partially about the cavity, as required to achieve desired results. Zones 40 and 42 additionally optionally include a plurality of non-nucleation sites 45, as will be explained. Zones 40 and 42 here are located at two elevations spaced above a base 46 of container 20 bounding a lower end of cavity 30, but locations being generally located in the upper ¾ or so of the height of the cavity. Zone 40 is located in a lower ½ of the height of cavity 30, and zone 42 is located within an upper ½ of the cavity, those locations being intended to be non-limiting and representative of typical locations for providing desired nucleation for a beer, ale, or stout served in a common pint glass such as container 20.

Addressing the nucleation sites 44 generally, they will preferably comprise imperfections or defects in or on inner surface 28 that will act to attract the carbonaceous compounds dissolved or in solution in the beverage 38, which when removed from solution will comprise molecules principally of carbon dioxide in the instance wherein beverage 38 is a beer. It can be recalled that the typical content of a carbonated beer will be between 1 and 4 volumes of carbon dioxide. For example, for 1 liter of beer carbonated to 2.7 volumes, that beer will contain about 2.7 liters of dissolved carbon dioxide gas. When the beer is depressurized, e.g., poured into a container such as container 20, due to partial pressure conditions present, some portion of the carbon dioxide will begin to nucleate to form gas bubbles within the beverage. This will be facilitated by and occur at nucleation sites 44 within the beverage, which nucleation sites 44 can be in the form of imperfections or small objects in or on the interior surface of the container, or particles of contaminants, such as dirt, dust, lint, salt, etc. It has generally been found that imperfections having small sharp edged particularly facilitate nucleation in beers. Thus advantageously, nucleation sites 44 principally comprise small imperfections or features on or in surface 28. Under normal circumstances, as is well known in the art, the bubbles will be attached to the surface or nucleation site by surface tension forces, and will expand as more of the gas comes out of solution at that site. The bubble will in turn increase in buoyancy, which will exert an upwardly directed buoyancy force thereagainst. If the buoyancy grows to become sufficient to overcome surface tension forces holding the bubble to the nucleation site, the bubble will detach and rise through the beverage.

Nucleation zones 40 and 42 have vertical extents or heights H1 and H3, respectively, (between lower and upper bounds thereof) selected to generate a desired number of bubbles for that zone. Additionally, the nucleation sites 44 of the respective zones 40 and 42 are arranged and of a density so as to cooperatively generate bubbles in an enhanced manner, so that the overall number of bubbles generated is increased, and can even be a multiple of the number that would be produced if the zones 40 and 42 functioned independently. The configuration and relationship of the zones 40 and 42 is also a factor in bubble size, which is overall preferably small compared to what would be produced using known nucleation methods. Thus it should be understood that the objective of the embodiment of the invention illustrated is the generation of numerous bubbles of a generally small size (e.g., barely visible to the unaided human eye with normal vision) to produce, build, or maintain a collar 48 on the upper surface 50 of beverage 38 having the desired characteristics, that can include, but are not limited to, creaminess, thickness, consistency, coverage, overall appearance, etc.

Generally, it will be desired, but not required, for lower zone 40 to be vertically spaced above base 46 by a lower nucleation site spacing dimension denoted as height H, preferably in which no significant enhanced nucleation capability will be present, for reasons to be explained. It is also desirable for zones 40 and 42 to be separated vertically by a space, referred to here as acceleration zone 52, having a height H2 for purposes of the invention. As representative non-limiting values, for a pint glass having an overall interior height of between about 5 and 8 inches, height H can be greater than 1 inch but less than 3 inches; and H1-H3 can each be a from a fraction of an inch, as anon-limiting example, ¼ inch, up to 2 inches or so, and H3 can be even greater, as desired or required for generating a desired collar. Upper zone 42 can be spaced below a top edge of the container by an upper nucleation site spacing dimension.

Referring in particular to FIG. 3, it should first be noted that both nucleation zones 40 and 42 can be intermittent, that is comprising clusters or groups of nucleation sites 44, represented by groups 54 and 56, that are arranged in a pattern or patterns, lines, etc., so as to form designs, letters, numbers, symbols, and the like, as desired for a particular application. As a non-limiting example, the group 54 may be representative of a number of nucleation sites 44 that would extend laterally (here vertically) across a horizontal line that would appear to be a thin line such as would be drawn with an ink pen or fine marker, to a person examining container 20. The groups can be connected or spaced, as illustrated by space 58, which can serve a purpose in addition to aesthetics, as will be explained. In FIGS. 2 and 3, it should be observed that a large number of bubbles 60 are shown in association with the nucleation sites 44 of the zones 40 and 42. It should also be observed that the bubbles 60 are largely disposed closely to inner surface 28, and in fact, are intended to flow upwardly along surface 28 as they rise through beverage 38, as illustrated by arrows 62, instead of rising vertically as would be the case for nucleation sites of the prior art. It has been found for a typical beer glass, e.g., glass 20, that a boundary layer having a thickness T of about ⅛th inch or less can be reliably generated even when the surface is inclined at a substantial angle relative to vertical.

In the above regard, it can be recalled from physics that bubbles rising through a liquid will accelerate as they rise, until they reach a terminal velocity as a function of size, depth, pressure, viscosity, etc., or reach the surface of the beverage. This principle is used advantageously according to the invention, in combination with the fluid dynamics principle of boundary layer effect, to directionally control the ascent of the bubbles, in particular, so as to travel along inner surface 28 so as to pass closely by the nucleation sites located thereabove, but importantly, not so as to significantly physically impact bubbles being formed there so as to burst the bubbles or coalesce therewith to form substantially larger bubbles, so as to prematurely detach at least some of the bubbles attached to the nucleation sites at higher elevations within the beverage. This is achieved by generation of a sufficient volume of the bubbles rising from the lower nucleation sites so as to create a boundary layer flow attached to inner surface 28, as illustrated in FIG. 4.

In accordance with known fluid dynamic principles, the flow of bubbles 60 comprising boundary layer 64 will have a velocity profile extending from surface 28 inwardly toward the center of cavity 30, ranging from zero velocity directly beside surface 28, a maximum velocity at about a middle of the boundary layer flow, and zero velocity at an maximum extent of the boundary layer flow next to a free stream region of the liquid beverage. The attached boundary layer flow of bubbles from lower nucleation sites will travel upwardly along the surface past higher sites, and at least portions of the flow will be accelerated.

It can also be recalled from fluid dynamics principles that an object moving through a fluid will generate an associated pressure wave that will travel with and propagate angularly away from the moving object, as can be readily seen as a bow wave of a boat as it moves through water. As the velocity of the moving object increases the pressure wave or bow wave will increase in forcefulness. It can also be observed that the pressure wave is thus a function of size or displacement of the object and its velocity—as either or both increase the force of the pressure wave is increased.

In the present invention, the acceleration and resultant velocity of rising bubbles will be generally known or determinable, and thus distances such as acceleration zone 52 can be used to regulate velocity of bubbles 60 rising from a lower location, e.g., zone 40, or lower within the same zone 40 or 42, past an upper location. Here, by utilizing nucleation, boundary layer attachment, and generally predictable bubble velocity, the effect is to cause the premature detachment of bubbles 60 at higher sites 44, so as to enter and rise with the upward flow. It has been found that this mechanism or effect can be advantageously used according to the invention to produces a larger number of small bubbles than would occur in its absence, as will be illustrated.

As another advantage, because the velocity of the boundary layer flow at surface 28 is zero or near zero, bubbles at that location will not be rising or will be rising very slowly, so that physical collisions and contact between rapidly rising bubbles and attached bubbles is minimal.

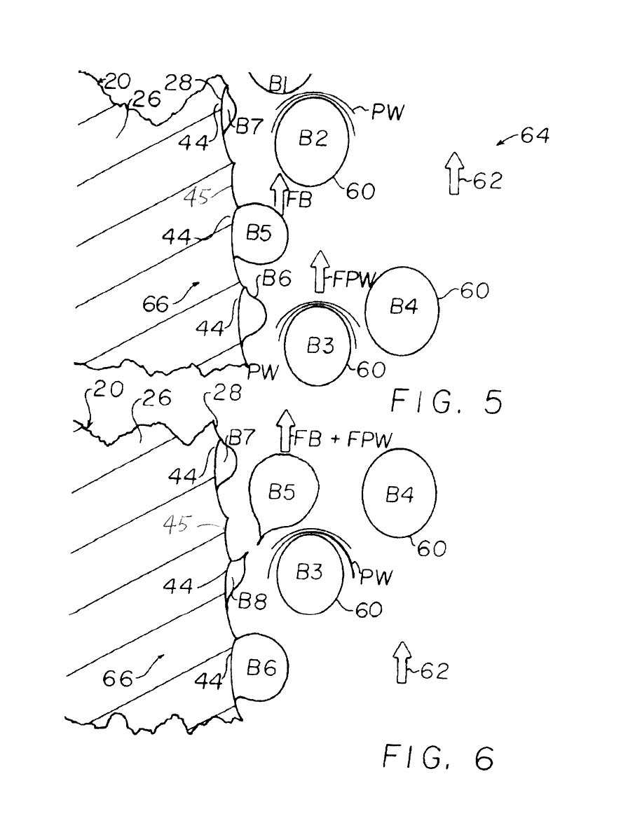

Referring more particularly to FIGS. 5 and 6, a sequence of flow of bubbles 60 of boundary layer 64 from a lower group of nucleation sites, past a representative upper group 66 of nucleation sites 44, is shown to illustrate the effect of the invention just described. It can be observed in FIG. 4 that representative bubbles 60, denoted bubbles B1, B2, B3 and B4, are rising past group 66 of nucleation sites 44, in the direction of arrow 62, along but spaced from inner surface 28 of sidewall 26. Bubbles B1, B2, and B3 are within effective range for potentially causing detachment of attached bubbles, here best illustrated by bubble B5, by virtue of the presence of the associated pressure wave PW. Bubble B4 is outside of range for causing detachment directly, but is a useful element for creation of the boundary layer flow, and ultimately adding to the collar formed on the surface of the beverage. In FIG. 5, bubbles B6 and B7 are still small and have less buoyancy.

In FIG. 6, bubbles B5, B6, and B7 are shown enlarged compared to in FIG. 5 as a result of accumulation of more gas. Bubble B5 is shown detached, as a result of the effect of passing pressure wave PW associated with bubble B3. This detachment is premature, and believed due to the combined forces acting on bubble B5, of its buoyancy force FB, and that exerted by the pressure wave FPW, as illustrated by associated arrows.

This is expressed as the function:

FB+FPW>ST=DETACHMENT

where ST is the surface tension attaching the bubble to the surface.

It is also contemplated that low pressure trailing regions following the rising bubbles, and/or the succession of multiple pressure waves, may be a factor in the bubble creation and detachment, by drawing the existing attached bubbles toward the upward flow stream after passage of the pressure waves, so that an oscillating or pulsing action is exerted against the attached bubbles to facilitate detachment. The trailing lower pressure region when passing the nucleation sites is also believed to act as a catalyst to the nucleation, mainly to accelerate formation and growth of the attached bubbles, perhaps because of the lower pressure.

When a bubble is detached in the above manner, because it has not grown to a sufficient size so as to have an adequate buoyancy force FB to detach on its own it will typically be smaller, and the detachment will occur earlier. As the detachment occurs, a residual seed bubble, here denoted as bubble B8, will form, which will grow into the next bubble at that site. It would be predicted that, in the illustration, the next bubble to detach will be bubble B6, due to its size. It should be recognized that the result of this bubble release mechanism will be the creation of a greater number of smaller bubbles.

It can be observed that the sidewall of container 20 is inclined between the upper and lower nucleation zones 40 and 42 and has an angle measured from horizontal. As a representative example, the separation distance between the upper nucleation zone 42 and the lower nucleation 40 can be between about 0.03 inches divided by cosine of the angle of the sidewall and about 0.06 inches divided by the cosine of the angle of the sidewall.

Examining FIG. 2 again, a lower region 68 of cavity 30 below lower nucleation zone 40 is shown including arrows 70 representing thermal convection pattern observed in that region, when at least lower zone 40 is actively nucleating bubbles. By use of dyes, it has been found that in region 68, instead of the thermal convection traveling up the sides of the container past zone 40, it appears to be blocked or terminated by the presence of the bubble generation in the lower nucleating zone 40, and cycle only or predominantly within the lower region 68. As a result of the limited thermal convection, it is expected that the beverage in the lower region will be subjected to less warming. Additionally, because of the absence of significant nucleating sites within lower region 68, there is less de-carbonation in that region, so that the beverage is fresher, that is, closer to original carbonation levels and less flat compared to if nucleation is present there in significant amounts. Further in this regard, it has been found that thermal convection flow within more central areas of cavity 30 is generally downward as illustrated by arrows 70. This can be significant as lower region 68 will be the last to be consumed, and its quality may be a factor in the ordering of a subsequent beverage.

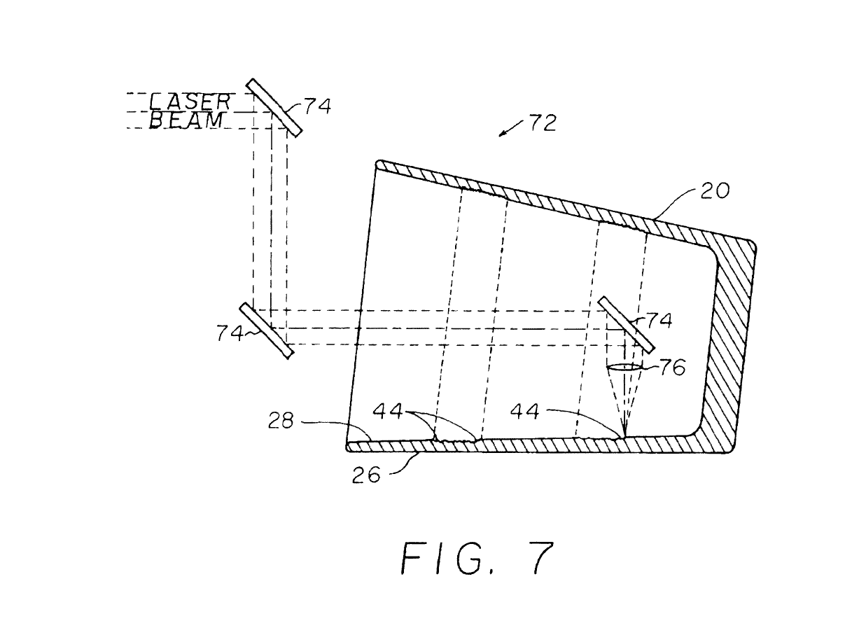

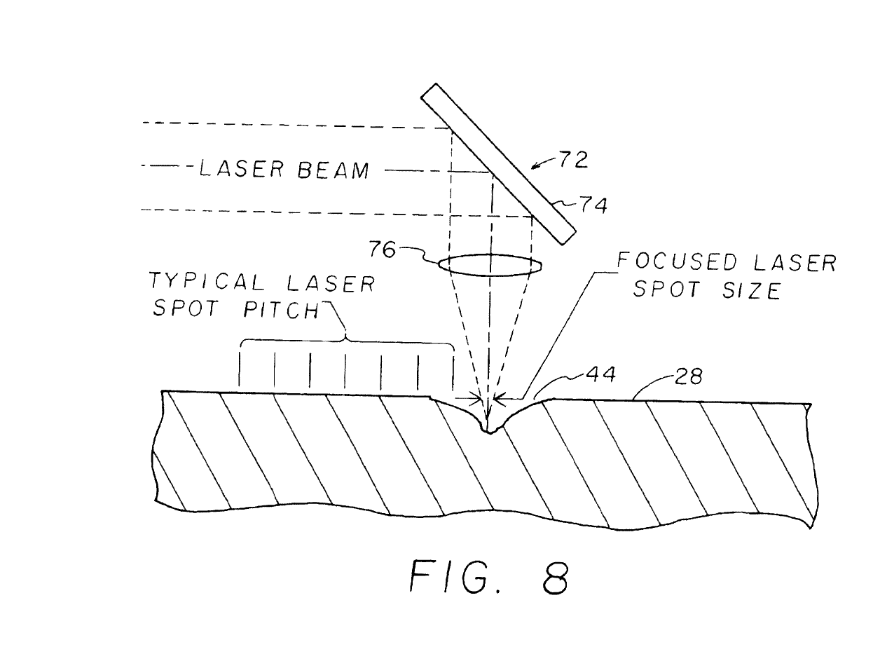

The nucleation sites 44 can be formed using any suitable techniques that provides the desired nucleation characteristics. Referring also to FIGS. 7 and 8, a laser apparatus 72 is shown schematically, and is representative of a wide variety of commercially available lasers operable to emit a pulsing beam capable of densely spalling a glass surface, such as inner surface 28 of sidewall 26 of container 20. Non-limiting examples of suitable laser apparatus are various carbon dioxide lasers available from Epilog Laser of Golden Colorado USA, in power levels of 40 or so watts, and presently capable of pulsing at up to 1200 dpi or so.

Apparatus 72, to be able to form nucleation sites 44 within container 20, will utilize one or more mirrors 74 and a focusing lens 76, for directing the beam onto surface 28. The power setting of the laser, repeat number of passes (if any), and pulse concentration, can be selected as desired or require for achieving desired results. As the laser is pulsing the container or laser will be rotated (or relatively rotated) to form the nucleation sites about surface 28 and the laser and container will be relatively moved to create the 2 dimensional array of nucleation sites. As an example, suitable apparatus can be provided to support and rotate container 20 about a central axis through its cavity, as the laser operates, and the laser and/or container can be moved axially to achieve the two dimensional creation of the nucleation sites.

It should be noted that it has been found that the density or resolution (dpi) of the laser pulses, denoted as spot pitch, will be smaller than the resulting nucleation sites 44. This is due to the spalling effect of the laser on the glass material, it being observed to essentially obliterate the glass material in proximity to the region where the laser impinges the glass surface, such that the nucleation site 44 will have characteristics of a shallow crater in the glass surface. For example, for a dpi of 1200, wherein the laser pulses will strike the glass surface every 1/1200 of an inch there will be overlapping of the spalling, as the individual craters will have a lateral extent larger than that size by perhaps a factor of several hundred percent. This has been found to be advantageous for the invention, as a 300 dpi setting can provide adequate spalling, with settings between 600 and 1200 dpi, with the laser at from about ½ to full power providing excellent results, e.g., craters having numerous highly defined ridges therebetween in a lattice like effect, and in large quantity to provide ideal and robust nucleation sites.

As a concern, it is possible that a given size of a nucleation zone or zones, or having a given number of nucleation sites, may produce too many bubbles for a given container and beverage and may result in dissatisfaction, for instance, by creating a head that is too thick, and/or too rapidly de-carbonating the beverage, which can result in flatness and unacceptable degradation of flavor. This can be problematic when it is desired to utilize or incorporate the nucleation sites as or into an image, such as a design, logo, trademark, or the like, of a certain size. This can be observed by the simplicity and small number of nucleation sites illustrated in the prior art patents referenced above in the Background section. Simply stated, if the design, logo, or the like comprises too many nucleation sites, the beverage and/or the drinking experience can be unacceptably degraded by too many bubbles produced by those sites. In contrast, if there are too few nucleation sites, the image may not be as visible and/or large as desired for its intended purpose. As another concern, for a given container material, laser power, and spot concentration, the spalling created by the laser may be too large, or rough or irregular in shape, so as to result in an undesirable appearance and/or performance.

To alleviate the above concerns, and achieve certain advantages, it has been discovered according to the invention that a laser apparatus such as apparatus 72 can be set such that some of the spalled sites are incapable of functioning as nucleation sites, are thus deemed non-nucleation sites, and that finer details and cleaner lines and boundaries with un-etched surface portions can be produced at those settings. It has also been discovered that settings can be found which will produce a mixture of nucleation capable or “nucleation” sites” and nucleation incapable or “non-nucleation sites”, and that a general ratio therebetween can be achieved. Thus, nucleation zones in which almost none of the sites are nucleation sites can be produced, as well as zones in which a substantially greater number of the sites are nucleation sites. The laser apparatus used to create the nucleation zones are programmable and can be set to produce a random mixture of nucleation sites and non-nucleation sites generally within a predictable proportional range, or can be programmed to produce a portion or portions of a zone having one proportion of nucleation to non-nucleation sites, and another portion or portions having a different proportion of nucleation to non-nucleation sites. And different zones can be produced having different proportions of nucleation/non-nucleation sites, respectively. As a non-limiting example, settings to produce zones 40 and 42 having from between about 20 percent to about 80 percent non-nucleation sites have been achieved and have utility for a variety of purposes.

In the above regard, it has been found that having non-nucleation sites 45 disposed between vertically separate nucleation sites within a nucleation zone 40 or 42 is advantageous as it provides an acceleration zone for bubbles rising from the lower nucleation sites, to increase detachment of bubbles from the upper sites and overall bubble production.

As another advantage, it has been discovered that a wide range of laser settings can be used to produce different proportions of nucleation to non-nucleation sites such that the nucleation sites and non-nucleation sites are visually identical or indistinguishable using the naked eye, or without magnification. Thus, a nucleation zone or line comprising a mixture of both nucleation sites and non-nucleation sites can be produced having a generally uniform textural appearance when viewed without magnification.

Settings for achieving the above results, will be a function of a number of factors, including the material being etched, such as tempered verses non-tempered glass, and different thicknesses of glass, size of the container, laser wattage or power used, and pulse frequency and proximity. Image appearance and how much bubble production is desired is also a factor, as it has been found that among different beverages, including different beers, the amount of bubble production will vary significantly for a given nucleation zone configuration.

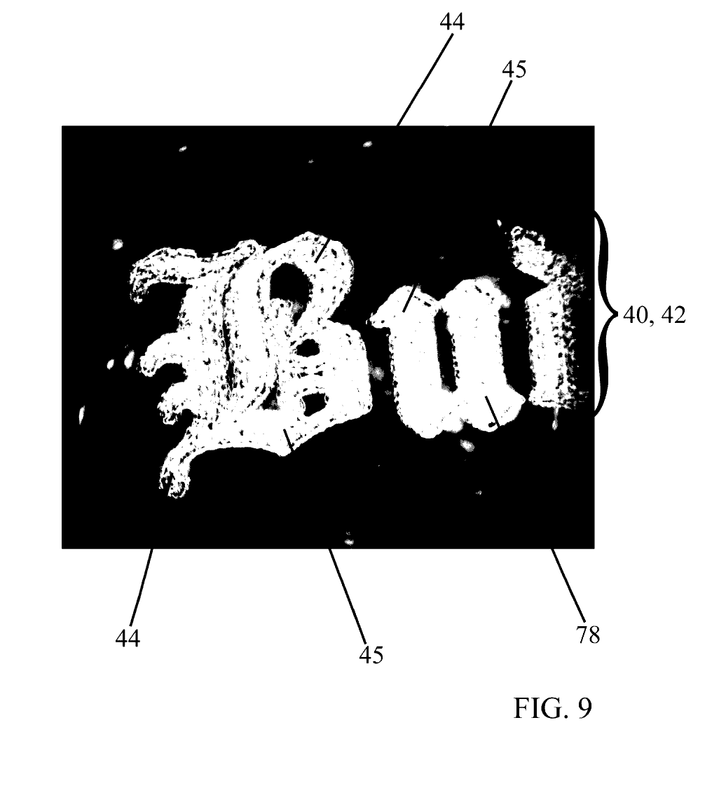

FIG. 9 shows a spalled glass including zones 40, 42 of nucleation sites 44 (in a dense mixture with non-nucleation sites 45) the mixture of both nucleation and non-nucleation sites being formed by a pulsing laser at a representative dpi and power setting within the above range, to create letters “B”, “u” and “d” in a size of a small fraction of an inch in height. The thin lines comprising a mixture of nucleation sites and non-nucleation sites comprising the letters have been found to provide excellent overall nucleation.

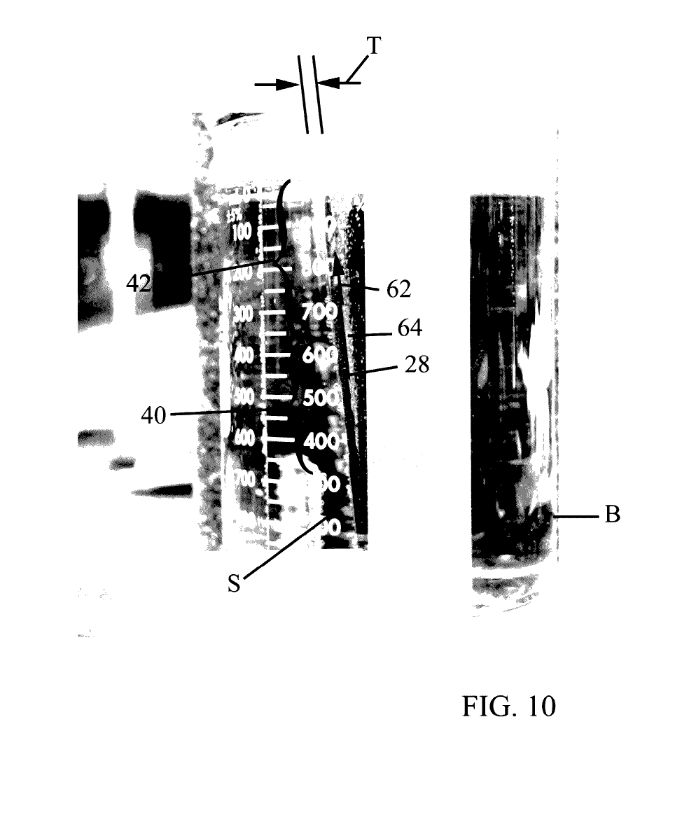

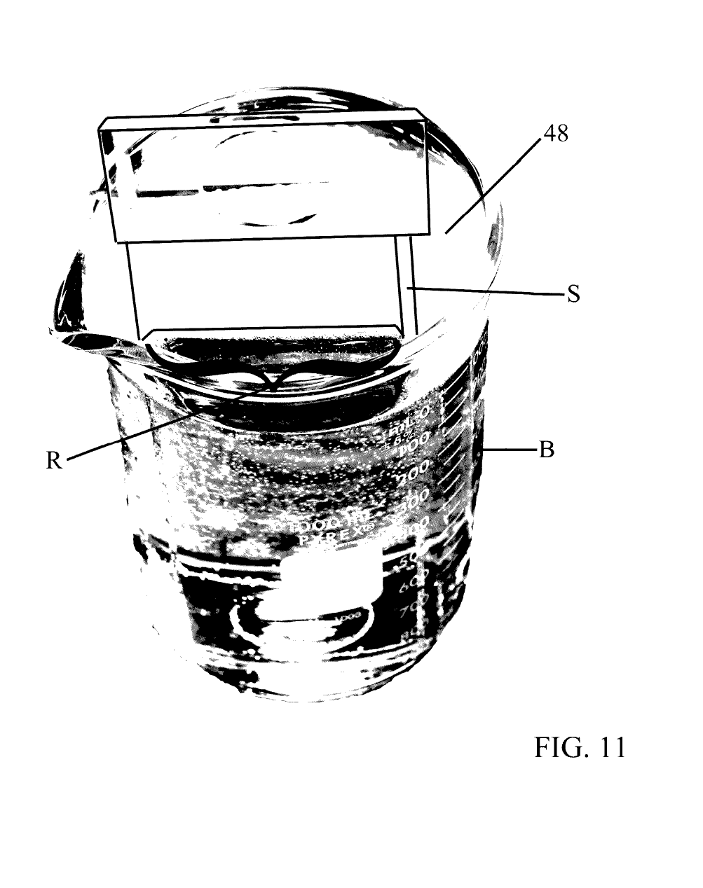

FIGS. 10 and 11 show a sample glass test specimen S comprising a glass plate including a surface 28 having representative nucleation zones 42 and 44 of nucleation sites and non-nucleation sites formed and positioned thereon according to the invention, immersed in a beaker B containing beer serving as the beverage. The test specimen S is tilted to orient surface 28 at a representative angle or incline of a sidewall of a beer pint glass which will be in a range of between about 3 and about 15 degrees typically. Attachment of an upward boundary layer flow of bubbles, denoted by arrow 62, to the inclined surface 28 is evident as compared to the accompanying vertical square. The boundary layer flow will have a thickness T, which will typically be about ⅛ inch or less. FIG. 11 shows a collar 48 created by the test specimen S, which collar completely covers the upper surface of the beverage with a fine cream to a desirable thickness. In contrast it can be observed in FIG. 11 that a region R of the beaker B entrapped by an opposite side of the test specimen S containing no nucleation sites, has no collar whatsoever.

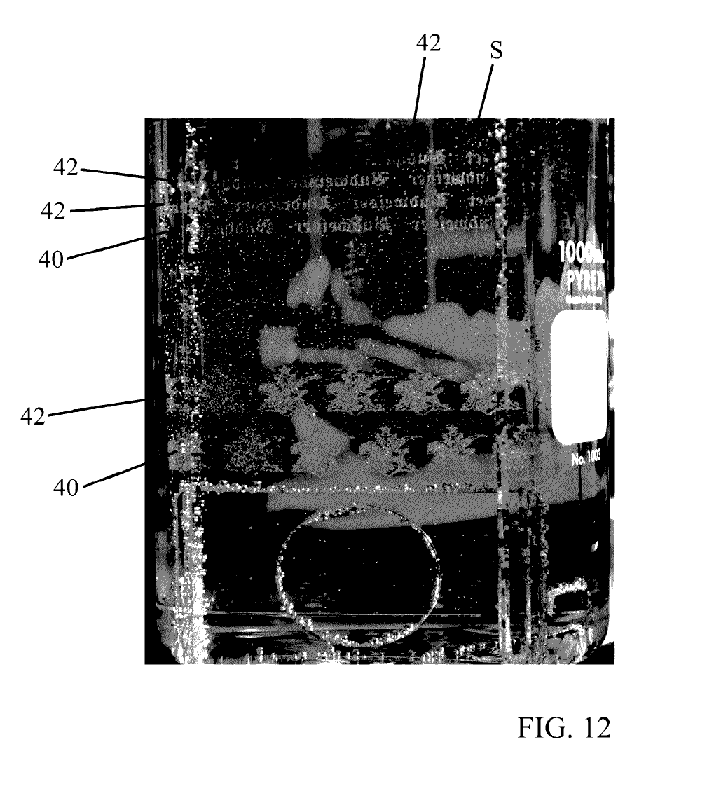

FIG. 12 shows the test specimen S including a non-limiting representative sample of designs and writing that can comprise the nucleation zones 40 and 42 comprising a mixture of nucleation sites and non-nucleation sites as typically desired for the lower and upper zones 40, 42 for a typical pint glass. It can be observed that the sites of the lower zone 40 comprise discrete, horizontally and vertically spaced apart designs comprising mixtures of small nucleation sites and non-nucleation sites, and the upper zone 40 comprise horizontal words formed of small letters comprising mixtures of nucleation sites and non-nucleation sites, in multiple vertical rows. This demonstrates that the zones 40, 42 at the two locations do not have to be continuous, and they can comprise useful commercial images. With this high density application of laser etching, even what visually appear to be thin lines, can actually contain a large sectional extent of the craters, ridges and nucleation sites, suitable to provide robust bubble generation.

Referring again to FIG. 2, the upper end of upper nucleation zone 42 can be observed as located close to or coexistent with the lower region of the collar zone of container 20, that is, close to or about even with pour line 32. As explained above, this is especially advantageous when the beverage has been dispensed with no or only a small collar, or the beverage has been dispensed into the container with adequate collar, but service to the consumer is delayed so that if a prior art container were used, the collar would be undesirably non-existent, small, or reduced when the beer is served. In this situation, when container 20 is filled sufficiently to immerse upper nucleation zone 42, it will operate to nucleate sufficiently to generate the desired collar quickly. Then, as the collar reaches and encompasses zone 42, nucleation at that location will be reduced so as to generate only sufficient bubbles to maintain the collar, or cease if the zone is completely ensconced in bubbles. Then, if the collar liquefies to such an extent that all or some of the sites of zone 42 are again immersed in liquid, nucleation will resume. All of these steps will occur automatically. Thereafter, as the beverage is consumed the upper nucleation sites will not be immersed, except when the container is tipped, and thus will no longer be a nucleating factor.

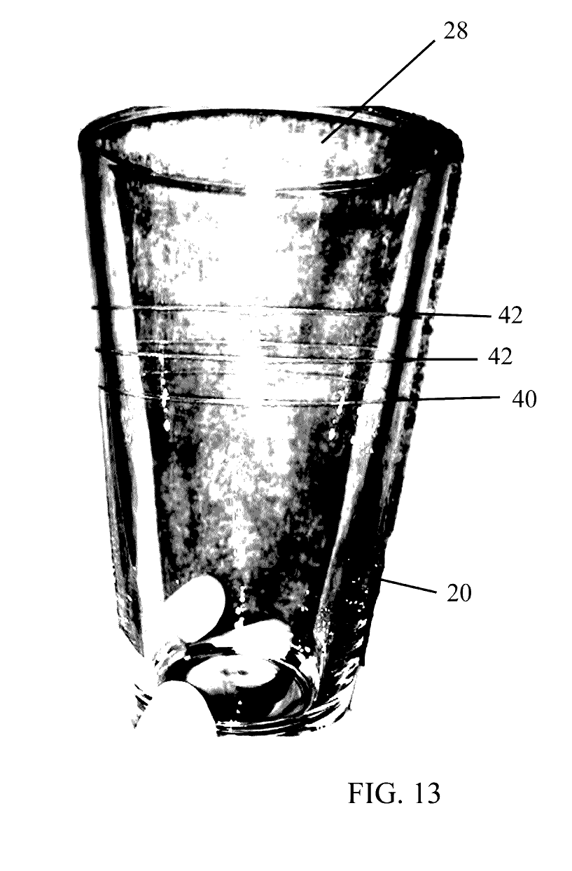

It should be understood that the nucleation zones of the present invention can be embodied in a variety of shapes and sizes, for a particular application, and therefore the preceding embodiment should not be considered as limiting. As an example, in FIG. 13 an image of another container which is a common pint beer glass 20 is shown, modified according to the invention to include three cooperating zones including a first lower zone 40 and two upper zones 42, comprising lines or rings of a mix of nucleation sites and non-nucleation sites about the inner surface 28 of the sidewall of the glass. Each of the lines can be observed to have a vertical extent sufficient to include multiple nucleation sites and non-nucleation sites for generating bubbles, and the lines can be positioned in vertically spaced relation advantageously for generating sufficient bubbles for maintaining an adequate collar or head when the glass contains beer so as to immerse the lines.

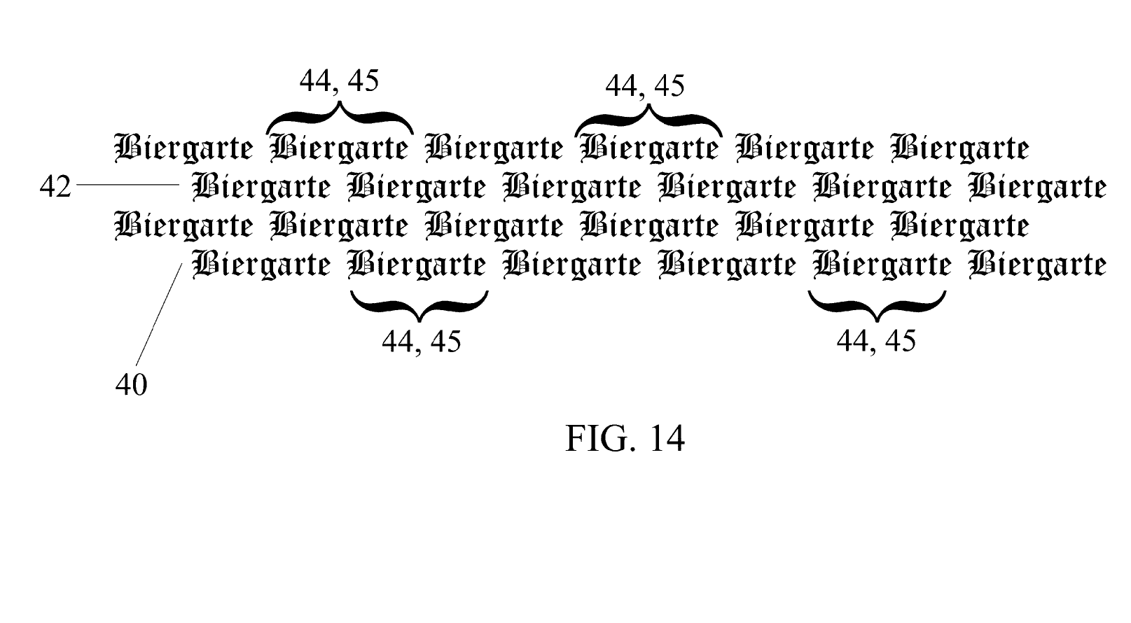

Referring also to FIGS. 14 through 19, additional non-limiting representative examples of possible configurations of nucleation zones 40 and 42 are illustrated.

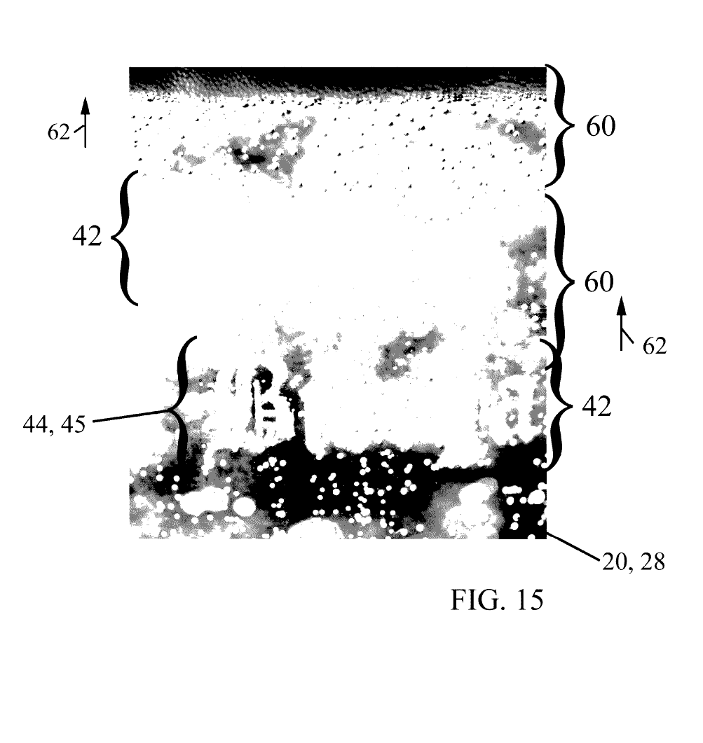

In FIGS. 14 and 15, a pattern of multiple nucleation zones 40, 42 comprising an intricate textual representation of the word “Biergarten” is shown. The pattern in FIG. 14 is sufficient to extend at least substantially about the periphery of a cavity of a container such as a beer glass. In FIG. 15, the nucleation ones 40 and 42 are shown on an inner surface 28 of a glass container 20, holding a carbonated beverage which is a commercially available Budweiser brand beer poured from a bottle maintained at a temperature of between about 33 and 38 degrees F. Zones 40 and 42 each comprise letters formed by mixtures of nucleation sites 44 and non-nucleation sites 45 which are individually visible but not distinguishable from one another. As can be seen through the glass, bubbles 60 formed and detached from the sites 44 are rising through the beer as denoted by arrows 62, toward a creamy head on the top of the beer, produced largely by the nucleating bubbles. It can be observed that not all of the visible sites produce bubbles, and thus some are evident as non-nucleation sites 45, and that fine detail (Gothic script) can be achieved. The individual letters are less than ⅓ inch tall or so. The head achieved is approximately ¼ inch thick and substantially completely covers the top surface of the beer. Longevity of the head exceeded 10 minutes with the container at room temperature and no drinks taken therefrom.

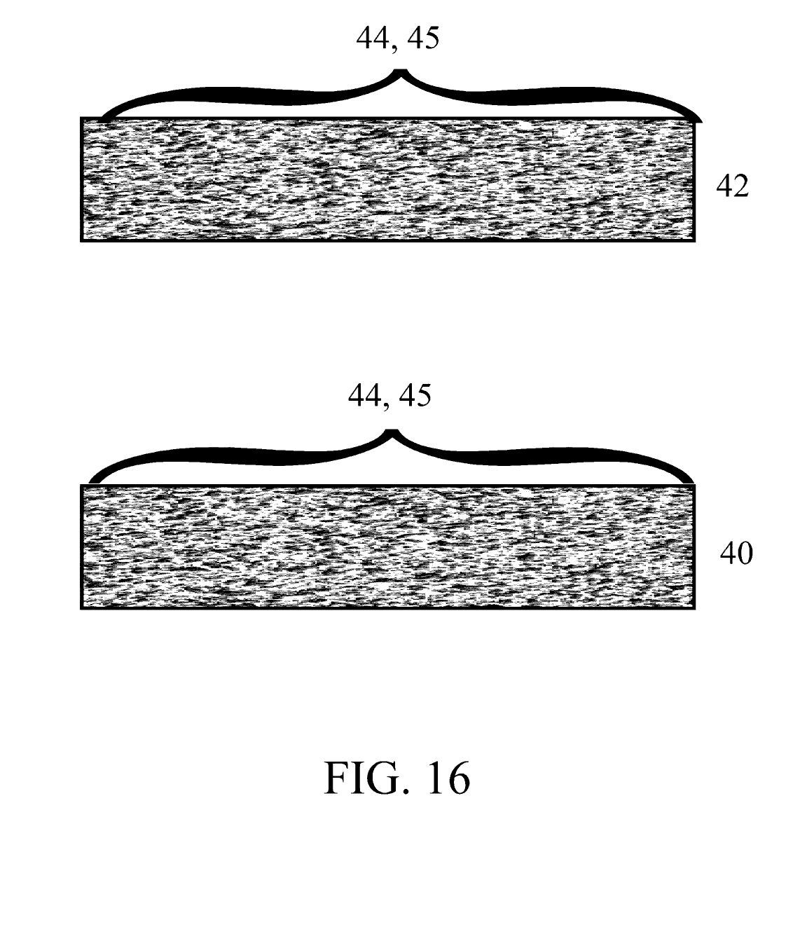

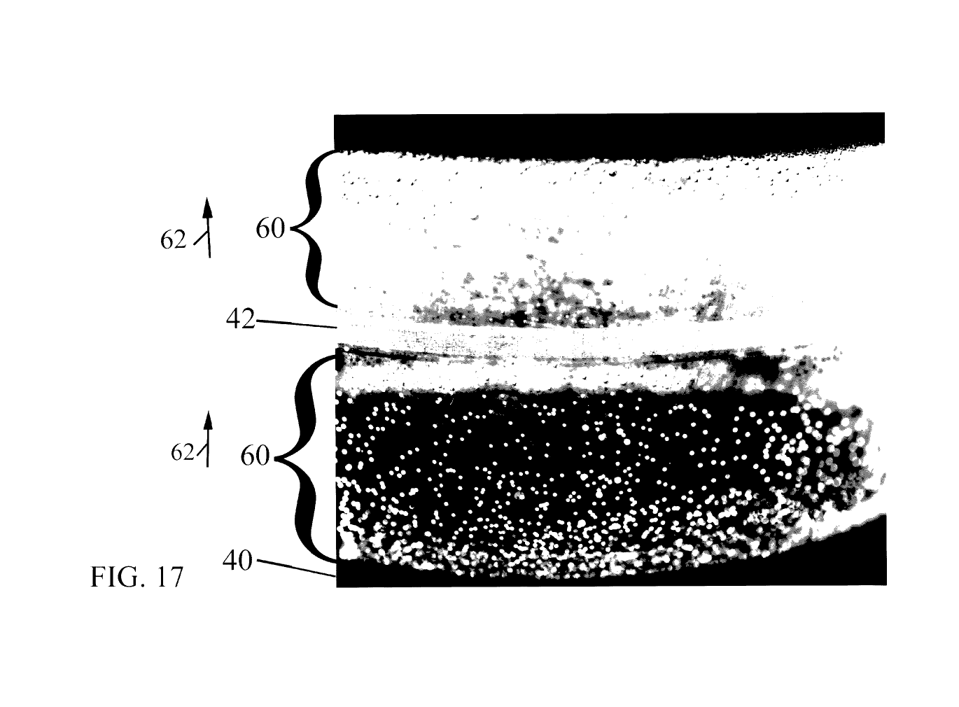

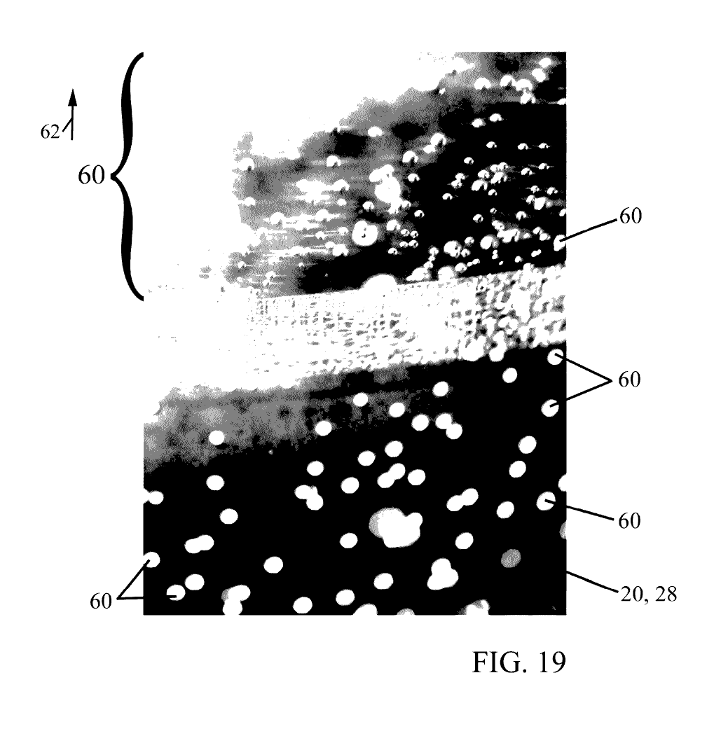

In FIGS. 16 through 19, another pattern of multiple nucleation zones 40, 42 comprising vertically spaced bars is shown. The pattern in FIG. 16 is an enlargement of a segment of the bars, which are sufficient in overall length to extend at least substantially about the periphery of a cavity of a container such as a beer glass, and comprise mixtures of nucleation sites 44 and non-nucleation sites 45. FIGS. 17, 18, and 19 are progressively enlarged views through a sidewall of a container having the nucleation zones 40 and 42 on an inner surface thereof. The container holds a carbonated beverage which is a commercially available Budweiser brand beer poured from a bottle maintained at a temperature of between about 33 and 38 degrees F. The bars of zones 40 and 42 each comprise a mixture of nucleation sites 44 and non-nucleation sites 45 which are individually visible as a texture but not distinguishable from one another. Bubbles 60 formed and detached from the sites 44 are shown rising through the beer as denoted by arrows 62, toward a creamy head on the top of the beer seen in FIG. 17, produced largely by the nucleating bubbles. It can be observed that not all of the visible sites produce bubbles, and thus some are evident as non-nucleation sites 45 and that sharp delineation of the bars from the smooth surface 28 of container 20 as shown in FIG. 19 is achieved. It can also be observed when viewing the actual bubble movements that having non-nucleation sites between vertically spaced ones of the nucleation sites appears to increase premature bubble detachment and overall bubble formation. The individual bars are less than ¼ inch tall or so. The head achieved is approximately ¼ inch thick and substantially completely covers the top surface of the beer. Longevity of the head again exceeded 10 minutes with the container at room temperature and no drinks taken therefrom.

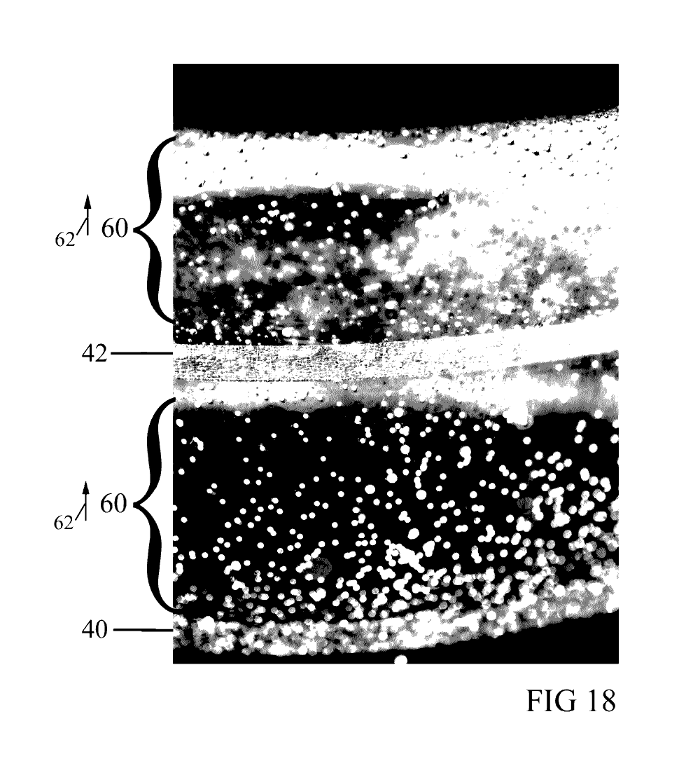

In FIGS. 17 and 18, it can be observed that the bubbles 60 rising from the lower zone 40 are farther apart as they rise, which is evidence of acceleration of the bubbles from the lower zone. It can also be observed in each of the FIGS. 17-19 that the bubbles rising from the upper zone 42 are noticeably smaller than those rising from the lower zone 40, evidencing that the bubbles detach prematurely from the upper zone 42.

In light of all the foregoing, it should thus be apparent to those skilled in the art that there has been shown and described an ENHANCED NUCLEATING BEVERAGE CONTAINER, SYSTEM, AND METHOD of the invention. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

1. An enhanced nucleating beverage container, comprising:
a base and an upstanding sidewall thereabout having an inner surface bounding and defining an upwardly open cavity for receiving and holding an effervescent beverage, the inner surface having an overall height; and
at least one array comprising a mixture of nucleation sites and non-nucleation sites disposed along at least a portion of the height of the inner surface, the nucleation sites being capable of generating and releasing bubbles when immersed in the beverage and the non-nucleation sites being substantially identical to the nucleation sites when viewed without magnification but incapable of producing bubbles when immersed in the beverage, at least some of nucleation sites being vertically spaced apart and at least some of the non-nucleation sites being disposed therebetween.

2. The beverage container of claim 1, wherein the nucleation sites and the non-nucleation sites each comprise craters on the inner surface.

3. The beverage container of claim 1, comprising a plurality of the arrays disposed about a periphery of the cavity.

4. The beverage container of claim 2, wherein the array is disposed within about an upper ¾th of the height of the inner surface.

5. The beverage container of claim 1, comprising at least two of the arrays disposed one above the other on the inner surface.

6. The beverage container of claim 5, wherein the at least two of the arrays are vertically spaced apart by at least about 1/10 inch.

7. The beverage container of claim 1, wherein the array comprises a band extending at least partially about a periphery of the cavity.

8. The beverage container of claim 1, wherein the array comprises at least one letter.

9. The beverage container of claim 1, wherein at least a portion of the nucleation sites and the non-nucleation sites of the array are contiguous.

10. The beverage container of claim 1, wherein there are at least about 300 of the nucleation sites and the non-nucleation sites per inch within the array.

11. The beverage container of claim 1, wherein the non-nucleation sites comprise between about 20 percent and about 80 percent of the mixture.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A method for enhancing nucleation and foam collar of a carbonated beverage held in a container, comprising steps of:
providing at least two zones or lines of nucleation sites extending at least partially peripherally about an upstanding sidewall of the container bounding an upwardly open cavity for receiving and holding the carbonated beverage, a first of the zones or lines of the nucleation sites being located at a first elevation spaced above a base of the container bounding a bottom of the cavity, and a second of the zones or lines of the nucleation sites being located at a second elevation a predetermined distance above the first elevation, such that, when the nucleation sites are immersed in the carbonated beverage, portions of the carbonation will come out of solution and form bubbles attached to the nucleation sites that will grow and detach therefrom and rise within the beverage;
depositing a sufficient quantity of the beverage in the cavity to immerse the at least two zones or lines of nucleation sites;
as the bubbles grow and detach from the nucleation sites and rise within the beverage, at least some of the bubbles rising from the nucleation sites at the first elevation will pass closely to the bubbles attached to the nucleation sites at the second elevation to cause at least some of the bubbles at the second elevation to prematurely detach and rise within the beverage; and
wherein at least one of the zones or lines of the nucleation sites comprises a plurality of non-nucleation sites mixed with the nucleation sites, the nucleation sites and the non-nucleation sites having substantially identical appearances when viewed without magnification.

29. The method of claim 28, wherein at least a portion of the bubbles that rise from the nucleation sites at the first elevation form a boundary layer flow that passes in close proximity to and interacts with the bubbles attached to the nucleation sites at the second elevation to cause the detachment thereof.

30. (canceled)

31. The method of claim 28, wherein the non-nucleating sites comprise from about 20 percent to about 80 percent of a sum of the nucleation sites and the non-nucleation sites.

32. The method of claim 28, wherein the nucleation sites and the non-nucleation sites comprise ridges and craters created by spalling of the inner surface of the sidewall by laser pulses.

33. The method of claim 28, wherein the bubbles rising from the nucleation sites create a convection flow of the beverage substantially separate from a convection flow of the beverage in a region of the cavity below the first elevation.

34. (canceled)

35. A system for enhancing nucleation and foam collar of a carbonated beverage held in a drinking container having a base and an upstanding sidewall thereabout comprising an inner surface bounding and defining an upwardly open cavity holding the carbonated beverage, comprising:
the inner surface of the sidewall including a zone or line of nucleation sites extending at least partially peripherally about the cavity, at at least two elevations spaced above the base, respectively, at least some of the nucleation sites being configured such that when immersed in the beverage some of the carbonation of the beverage held in the cavity will form bubbles attached to the sites, respectively, and wherein the bubbles will grow in size then detach from the sites, respectively, and rise through the beverage along the sidewall, and wherein at least some of the bubbles that detach and rise from the nucleation sites at a lower of the elevations will pass closely to some of the nucleation sites at a higher of the elevations in a manner to cause bubbles attached thereto to detach at an increased rate; and
a plurality of non-nucleation sites in a mixture with the nucleation sites, the nucleation sites and the non-nucleation sites being substantially identical when viewed without magnification.

36. The system of claim 35, wherein the higher of the elevations is a predetermined distance above the lower of the elevations, such that at least some of the bubbles that detach and rise from the sites at the lower of the elevations will accelerate to a velocity when passing the higher of the elevations sufficient to disturb and cause at least some of the bubbles attached to the sites at the higher of the elevations to detach therefrom prematurely.

37. The system of claim 35, wherein the nucleation sites are configured such that the bubbles that rise from the nucleation sites at the lower of the elevations, and at the higher of the elevations, will rise together in a convection flow within the beverage beside the sidewall, separate from a convection flow of the beverage below the lower of the elevations.

38. (canceled)

39. (canceled)

40. The system of claim 35, wherein the nucleation sites and the non-nucleation sites comprise ridges and craters in the surface of the container.

41. (canceled)

42. (canceled)

43. (canceled)

44. (canceled)

45. (canceled)

46. (canceled)

47. (canceled)

48. (canceled)

49. (canceled)

50. (canceled)

51. (canceled)
